(19) United States
(12) Patent Application Publication
(10) Pub. No.: US 2024/0111963 A1
(43) Pub. Date: Apr. 4, 2024

(54) Viewpoint Camp Visualization

(71) Applicant: INTERNATIONAL BUSINESS MACHINES CORPORATION, ARMONK, NY (US)

(72) Inventors: Jin Shi, Ningbo (CN); Wen Juan Nie, Ningbo (CN); Jing Lei Guo, Ningbo (CN); Lu Fu, Ningbo (CN); Ke Huan Yin, Ningbo (CN); Jie Jiang, Ningbo (CN)

(21) Appl. No.: 17/937,638

(22) Filed: Oct. 3, 2022

(51) Int. Cl. G06F 40/40; G06F 40/20; G06F 40/30; G06T 11/20

(52) U.S. Cl. CPC G06F 40/40; G06F 40/20; G06F 40/30; G06T 11/206

(57) ABSTRACT

Techniques are described with respect to a system, method, and computer product for visualizing viewpoints. An associated method includes receiving access to a multi-party discussion occurring via a telecommunication system and analyzing the multi-party discussion using natural language processing. The method further includes extracting a plurality of viewpoints of the multi-party discussion based on the analysis, synthesizing a subset of the plurality of viewpoints based on the content of each viewpoint of the plurality of viewpoints, and transmitting a rendered synthesized visualization of the subset.

### BACKGROUND

The present invention relates generally to cognitive computing environments. More particularly, the present invention relates to visualization of viewpoints for participants in discussions that occur using telecommunication systems.

The process by which participants of multi-party discussions and meetings in telecommunications systems reach a consensus inherently includes a multitude of difficulties and limitations. These difficulties and limitations are imposed by factors such as abundance of participants and their viewpoints, divergence of said viewpoints, lack of engagement of participants, unwillingness of participants to publicly express sentiments regarding viewpoints, etc. In addition, these aforementioned difficulties and limitations result in high cognitive burdens imposed on decision makers and consensuses that do not accurately reflect those of the entire group.

### SUMMARY

Additional aspects and/or advantages will be set forth in part in the description which follows and, in part, will be apparent from the description, or may be learned by practice of the invention.

A system, method, and computer product for visualizing viewpoints is disclosed herein. In some embodiments, the computer-implemented method for visualizing viewpoints includes receiving access to a multi-party discussion occurring via a telecommunication system; analyzing the multi-party discussion using natural language processing; extracting a plurality of viewpoints of the multi-party discussion based on the analysis; synthesizing a subset of the plurality of viewpoints based on the content of each viewpoint of the plurality of viewpoints; and transmitting a rendered synthesized visualization of the subset.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary network diagram depicting a network environment, according to an exemplary embodiment;

FIG. 2 illustrates a diagram associated with a viewpoint visualization system, according to an exemplary embodiment;

FIG. 3 is a diagram of a user interface illustrating a visualization of a viewpoint camp, according to an exemplary embodiment;

FIG. 4 is a diagram of a user interface illustrating a visualization of grouping of participants based on viewpoints, according to at least one embodiment;

FIG. 5 illustrates a flowchart depicting a method for visualizing viewpoints, according to at least one embodiment;

FIG. 6 depicts a block diagram illustrating components of the software application of FIG. 1, in accordance with an embodiment of the invention;

FIG. 7 depicts a cloud-computing environment, in accordance with an embodiment of the present invention; and

FIG. 8 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for visualizing viewpoints. Due to the inherent difficulties and limitations associated with reaching a consensus, issues such as divergence of viewpoints of participants in multi-party discussions prolong the already long process of ascertaining a consensus within a multi-party discussion. Viewpoints may be directly impacted within the discussion due to various factors such as participants not being on the same page regarding a matter of the discussion, late or absent participants playing catch up on components of the discussion, participant lack of desire to vote publicly in order to avoid creating biases, etc. It would be helpful to have a means to visualize not only viewpoints within multi-party discussions, but also the convergence of viewpoints and overall consensus of a multi-party discussion gathered from the viewpoints. The present embodiments have the capacity to visualize viewpoints of participants within multi-party discussions and meetings in order to synthesize arguments and viewpoints of the participants. The present embodiments accomplish the visualization by generating graphs and other applicable visual representations including quantifiable features to represent statements, emotions/sentiments, consensuses reached within the multi-party discussions, precedence of viewpoints, etc. The visualizations may be accomplished by utilizing artificial intelligence and machine learning technologies to analyze statements within the multi-party discussions based on factors/attributes including, but not limited to statement semantics, statement order/priority, discussion context, semantics, emotions, etc.

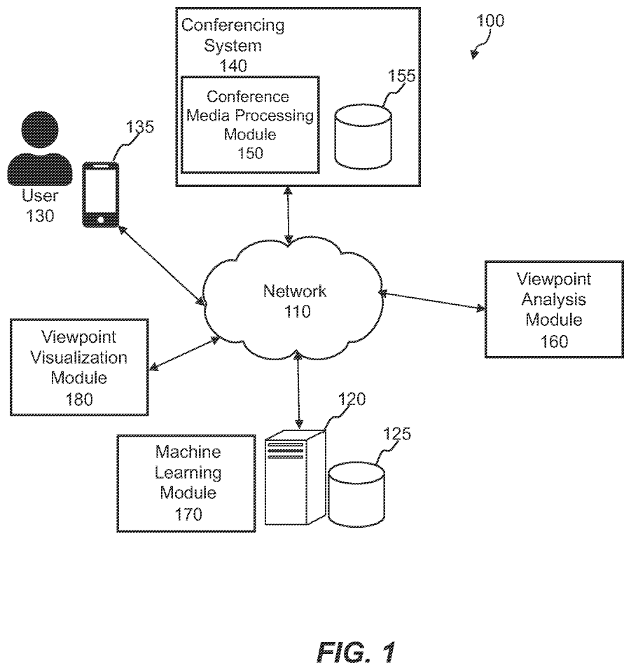

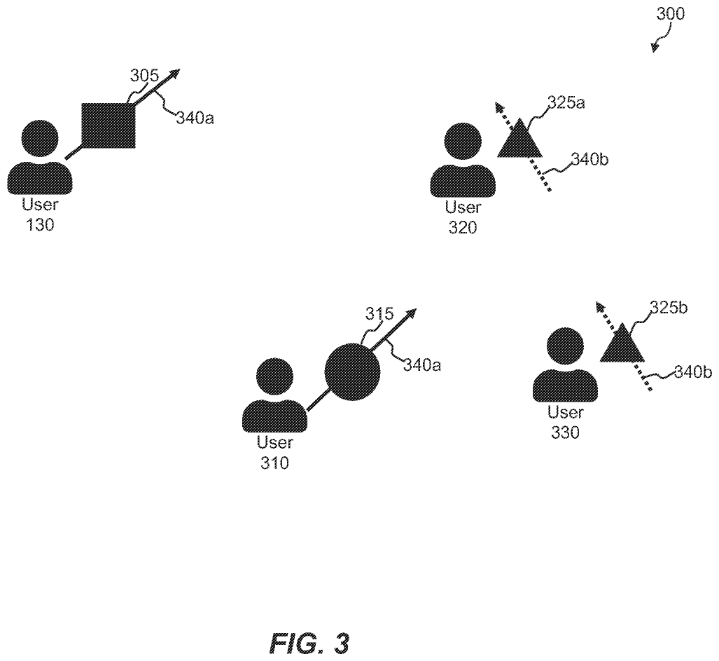

FIG. 1 shows a network environment 100 for a viewpoint visualization system, according to an exemplary embodiment. Environment 100 includes a server 120 communicatively coupled to a server database 125, a user 130 associated with a computing device 135, a conferencing system 140 configured for facilitating channels of communication including a conference media processing module 150 is configured to process data derived from the channels of communication (e.g. audio data, video data, text data, etc.), a conference media database 155 communicatively coupled to conference media processing module 150, a viewpoint analysis module 160, a machine learning module 170 communicatively coupled to server 120, and a viewpoint visualization module 180, each of which are communicatively coupled over network 110. FIG. 1 provides only an illustration of implementation and does not imply any limitations regarding the environments in which different embodiments may be implemented. Modifications to environment 100 may be made by those skilled in the art without departing from the scope of the invention as recited by the claims. Environment 100 is a network of computers in which the illustrative embodiments may be implemented, and network 110 is the medium used to provide communications links between various devices and computers connected together within environment 100. Network 110 may include connections, such as wire, wireless communication links, or fiber optic cables. Network 110 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. It should be appreciated that FIG. 1 provides only an illustration of one implementation and does not imply any limitations with regard to the environments in which different embodiments may be implemented. Many modifications to the depicted environments may be made based on design and implementation requirements. For example, conferencing management module 150, viewpoint analysis module 160, machine learning module 170, and viewpoint visualization module 180 may be components or and/or associated with software/hardware components of server 120. Computing device 135 may include, without limitation, smartphones, tablet computers, laptop computers, desktop computers, wearable device, and/or other applicable hardware/software configure to support telecommunication applications. Although only one user 130 and computing device 135 is shown, in implementations (as shown in FIG. 3), more computing devices can be in communication with the system shown over network 110. Various embodiments are envisioned without departing from the scope of the invention. Server 120 is designed to host a centralized platform for computing device 135 to access in order to interact with visualizations of multi-party discussions generated by viewpoint visualization module 180.

In addition to facilitating and/or receiving channels of telecommunication, embodiments of conferencing system 140 provide configurations to support live-meetings in virtual venues as well as non-virtual venues, such as a conference room including audiovisual equipment to monitor participants in a multi-party discussion. Applicable audiovisual equipment may be standalone, networked products, or may be webcams and sensors (e.g. cameras, microphones, etc.) from computing devices of participants in the conference room. In some embodiments, conferencing system 140 includes a telephony system such as POTS, PBX, VoIP, or other suitable type of telephony service known to those of ordinary skill in the art. Inclusion of the telephony system allows conferencing system 140 to access multi-party discussions via telephone devices if applicable in which the content of the multi-party discussions are captured via sensors of computing device 135.

As conferencing system 140 facilitates and/or receives multi-party discussions via channels of communication, viewpoints of user 130 and other users operating on the centralized platform (collectively referred to as “participants”) are ascertained by viewpoint analysis module 160 based on multi-party discussion media content processed via conference media processing module 150 from the multi-party discussions. Conference media processing module 150 stores data derived from the processing of multi-party discussion media content (e.g. video data, audio data, text data, participant location data, time data, etc.) into conference media database 155. In some embodiments, multi-party discussion media content is specific to the one or more dialogues associated with the multi-party discussions and data derived from the processing of multi-party discussion media content includes, but is not limited to topics derived from participant statements within dialogues, viewpoints derived from participant statements and participant sentiments, consensuses and inherent votes associated with viewpoints, or any other applicable data associated with multi-party discussions known to those of ordinary skill in the art. In some embodiments, conference media processing module 150 converts the audio data of the dialogues of multi-party discussions into transcripts which are stored in conference media database 155. One purpose behind transcribing the dialogues is to assist viewpoint analysis module 160 with the analyses of the dialogues in order to not only obtain statements of participants within the dialogue, but also the viewpoints of the participants within the dialogues, sentiments of the viewpoints, etc. In addition, consensuses, votes, conclusions, decisions, etc. at any specific point of time during the dialogue may be ascertained.

Viewpoint analysis module 160 is designed to ascertain conclusions, decisions, consensuses (including near-consensuses), etc. derived from identified viewpoints of participants. In addition, viewpoint analysis module 160 determines/identifies emotions, sentiments, semantics, and ordering/prioritization associated with the viewpoints, in which each of the aforementioned may be utilized as factors for viewpoint analysis module 160 to calculate a degree of consensus among participants in multi-party discussions and assign a viewpoint score to viewpoints. In some embodiments, viewpoint analysis module 160 performs the analyses by utilizing assistance from machine learning module 170, in which machine learning module 170 utilizes one or more machine learning models trained based on training datasets including data derived from one or more of server database 125, conference media database 155, multi-party discussion media content, and outputs of iterations of the machine learning models. Outputs of the machine learning models can be used to train future iterations of the machine learning models by a topical analysis, by breaking down dialogues based on topic, or by a neural network machine learning and creating a feedback loop based on best results. In the feedback loop, system output can be used as input to guide future operation. Viewpoint analysis module 160 may determine sentiments, semantics, and ordering/prioritization associated with the viewpoints and statements thereof by machine learning module 170 performing natural language processing (“NLP”). In some embodiments, the NLP is performed on one or more transcripts of the participants' dialogue within the multi-party discussion allowing participant statements to be detected and viewpoints to be ascertained. Machine learning module 170 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure.

Viewpoint visualization module 180 is designed to render one or more visualizations of the viewpoints of the participants within multi-party discussions including, but not limited to dynamic graphs representing the statements of a participant, viewpoints derived from the statements, sentiments associated with the viewpoints, synthesizing of the viewpoints pertaining to a topic or dialogue within the multi-party discussion, quantified visual indicators of emotions of the participants, merging of viewpoints of participants (e.g. concurring viewpoints of participants), visual representations of statement semantics and priority/precedence of viewpoints, and other applicable visualizations of a viewpoint camp provided by the centralized platform. Generally, the dynamic graphs may illustrate the viewpoints of participants, relationships between the viewpoints, timeslots associated with the transcript of a multi-party discussion illustrating when statements and votes during dialogue are made, etc. Viewpoint visualization module 180 may present one or more viewpoint graphs corresponding to a timeline associated with the transcript of a multi-party discussion including visual indicators of participant statements and attributes of said statements. Viewpoint visualization module 180 may be represented by one or more data structures (e.g. server database 125, conference media database 155 database, collection of outputs of machine learning module 170, etc.), and data within the data structures may be modifiable by participants via user interfaces provided by the centralized platform on computing device 135. Viewpoint visualization module 180 may support various types of viewpoint visualizations including but not limited to relationship graphs, relationship curves, partial relationship graphs, emotion curves, etc.

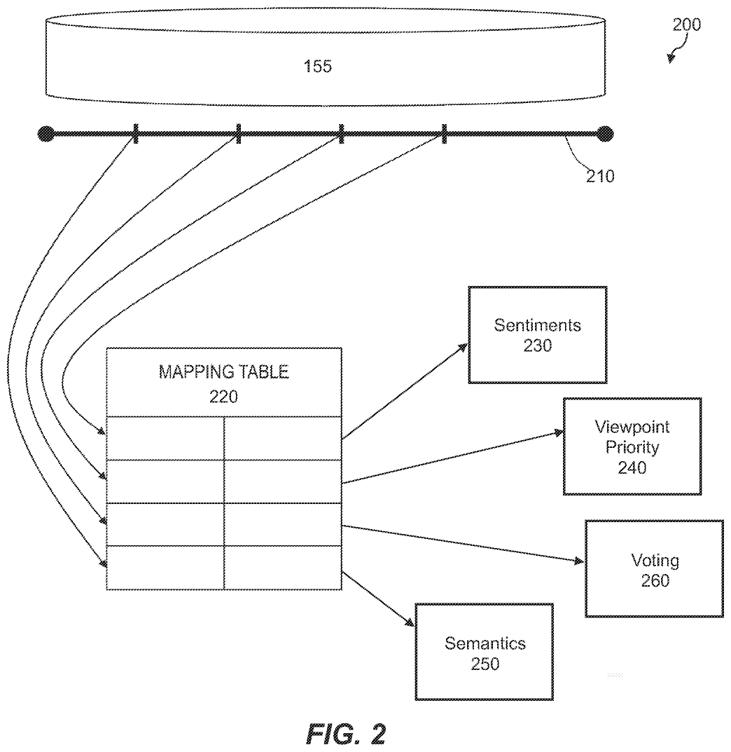

Referring to FIG. 2, a diagram 200 associated with the viewpoint visualization system is depicted, according to an exemplary embodiment. Conference media processing module 150 transcribes multi-party discussions into a plurality of transcripts for storage in conference media database 155. The transcribing of the multi-party discussions in performed in a manner in which machine learning module 170 utilizes training to create and store transcripts of the dialogues of the multi-party discussions including participant statements, in which speech patterns within the statements that represent viewpoints are marked and stored as a viewpoint corpus in conference media database 155. Machine learning module 170 may train a machine learning based conversational agent associated with conferencing system 140, in which the conversational agent performs the marking of the speech patterns within the statements that collectively represent a viewpoint of a participant and/or a derivative thereof (e.g., statements of viewpoints, attributes of viewpoints, etc.).

In some embodiments, viewpoint visualization module 180 generates a timeline 210 corresponding to the transcript representing a multi-party discussion. One purpose of timeline 210 is to assist a mapping table 220 operated by viewpoint analysis module 160 to map components derived from the analyses of multi-party discussions performed by viewpoint analysis module 160 to timeline 210. Components of multi-party discussions ascertained by viewpoint analysis module 160 include, but are not limited to viewpoint sentiments 230, viewpoint priority/ordering 240, viewpoint semantics 250, etc. For example, user 130 provides input regarding a subject matter within the dialogue of a multi-party discussion, in which the multi-party discussion is transcribed by conference media processing module 150, viewpoint analysis module 160 analyzes the transcript, and viewpoint visualization module 180 renders timeline 210. Viewpoint analysis module 160 filters the transcript for viewpoints of participants within the dialogue of the multi-party discussion. Upon detection of a viewpoint within the dialogue, viewpoint analysis module 160 extracts a weight (Wi), an emotion/sentiment (REi), and a similarity (Rsi) of the viewpoint, in which each of the aforementioned are attributes that viewpoint visualization module 180 may represent in the one or more visualizations of the viewpoints.

Utilizing topic identification, viewpoint detection, sentiment analysis, and the extracted attributes, machine learning module 170 will be able to predict which path, textual and/or conferenced communication, would result in the least time for issue resolution. The extracted viewpoint attributes along with factors identified by textual analysis of the transcript are weighted to assist in the running of models. Factor weights can be assigned initial conditions by one or more of users operating on the centralized platform, server 120, viewpoint analysis module 160, and/or machine learning module 170, and can be updated as the models are trained and used in prediction. In some embodiments, viewpoint analysis module 160 performs a clustering process in order to synthesize viewpoints. For example once the transcript of the multi-party discussion is rendered, viewpoint analysis module 160 identifies a topic of dialogue of the multi-party discussion and generates a viewpoint vector including the plurality of viewpoints of the multi-party discussion based on the one or more analyses of the multi-party discussion performed by viewpoint analysis module 160. The viewpoint vector may include a spectrum of viewpoints organized based on one or more of a sentiment score assigned by viewpoint analysis module 160 to the respective viewpoints (e.g. the more positive the sentiment the higher the score), a priority/ordering score assigned by viewpoint analysis module 160, a semantics score assigned by viewpoint analysis module 160, or any combination thereof. The priority/ordering score may be based on the role, ranking, title, etc. of the participant who the viewpoint belongs to may be used to prevent over-fluctuation that directly impacts scores. Multi-party discussion participants with extreme or overbearing personalities reflected in their ascertained statement sentiments may be assigned a lower priority score, while participants having the title of director, manager, etc. may have a higher priority score assigned. Groups, sub-groups, or clusters of viewpoints is accomplished by viewpoint analysis module 160 using clustering algorithms such as k-mean, fuzzy clustering, etc.

In order to ascertain a nexus among viewpoints, viewpoint analysis module 160 calculates distances between the viewpoints within the viewpoint vector which results in a similarity metric between the viewpoints. The similarity metric is configured to assist viewpoint analysis module 160 with determining the Rsi of each viewpoint of the viewpoint vector, which is weighed as a factor when viewpoint analysis module 160 calculates a viewpoint score assigned to the viewpoints. In addition, distance metrics allow viewpoint analysis module 160 to determine distance between viewpoints in order for viewpoint analysis module 160 to ascertain a consensus among the participants regarding a viewpoint within the viewpoint vector. The consensus may pertain to a identified topic of the dialogue, such as a call to vote for said topic.

In some embodiments, viewpoint analysis module 160 utilizes mapping table 220 as a data model used to map voting 260 of participants to positions regarding the topic or matter the viewpoint is associated with in order to assist with gathering a consensus regarding the topic or matter. Viewpoint visualization module 180 may visualize viewpoints, voting 260, and consensuses reached by participants in a variety of manners. For example, positions reflected in the viewpoints of participants may be displayed in a graph including a plurality of nodes representing participants of a multi-party discussion, in which the x and y axes may pertain to one or more of viewpoint sentiment, viewpoint priority, viewpoint semantics, degree of consensus, time slots of timeline 210 (e.g. point in time of the dialogue when a participant expresses viewpoint), viewpoint score, etc. The positions of the plurality of nodes within the graph may continuously be reflected within the visualization in real-time. For example, as the dialogue continuously progresses the incrementing time slots will iteratively change adding participants to a grouping that agrees or disagrees with a viewpoint expressed during the dialogue.

The visualization of the plurality of nodes within the graph correlate with the continuous calculation of the viewpoint score, in which the extracted viewpoint attributes are weighed into the calculation. For example, Wi may decrease along timeline 210; however, newer acquired viewpoints generally include a higher weight due to the accumulative effect. In some embodiments, viewpoint analysis module 160 calculates the viewpoint score utilizing the following equation: ΣRsi*REi*Wi, in which the real-time updating of the viewpoint score is reflected in the graph based upon conferencing system 140 continuously receiving dialogue of the multi-party discussion for processing by conference media processing module 150.

Referring now to FIG. 3, an exemplary user interface 300 of participants of a multi-party discussion is depicted. As shown, user 130 is engaged in the multi-party discussion dialogue operated by conferencing system 140 with users 310, 320, and 330 via applicable computing devices. During the dialogue, user 130 expresses viewpoint 305 regarding the dialogue, user 310 conveys viewpoint 315, user 320 expresses viewpoint 325a, and user 330 expresses viewpoint 325b, each of which are associated with the dialogue of the multi-party discussion. As depicted, viewpoints 305, 315, 325a, and 325b are designed to be visualized by viewpoint visualization module 180 as shapes, color-coded markers, or any other applicable visual indicators known to those of ordinary skill in the art. As shown, viewpoints 325a and 325b align with each other which is indicated by both having a triangular shape representing viewpoints 325a and 325b, in which viewpoints 325a and 325b are a subset of viewpoints of the dialogue that are configured to be synthesized based on viewpoint analysis module 160 determining that the content of viewpoints 325a and 325b (e.g. summarization of the statements of the viewpoints) are similar and/or contain the same sentiment, in which the synthesized viewpoints are depicted in one or more visualizations rendered by viewpoint visualization module 180. Viewpoint visualization module 180 may further provide visual representations of the markings of speech patterns within the statements of participants in order optimize depiction of the attributes of statements derived from the analyses performed by viewpoint analysis module 160. In some embodiments, user interface 300 is designed by viewpoint visualization module 180 to include one or more lines 340a and 340b associated with the viewpoints configured to indicate whether the viewpoints include a positive sentiment or a negative sentiment associated with the viewpoints of the dialogue. For example due to the negative sentiment, viewpoints 325a and 325b are associated with dotted line 340b while viewpoints 305 and 315 are associated with solid line 340a indicating positive sentiment. In various embodiments, lines 340a and 340b align with timeline 210 allowing time slots to be accounted for in a manner in which viewpoint visualization module 180 depicts viewpoints, associated sentiments, time points in the dialogue in which viewpoints and/or derived statement thereof were established, and any other applicable attributes associated with the viewpoints configured to be visualized in accurate chronological order.

It should be noted that the viewpoints may include a plurality of statements of participants associated with the multi-party dialogue. In some embodiments, viewpoint analysis module 160 assigns statement scores to each of the statements based on associated statement sentiments, statement priority/ordering, and/or statement semantics in order for viewpoint analysis module 160 to assign the viewpoint score to the statement. Sentiments pertain to the emotions expressed within the content of the participant's statement, priority/ordering pertains to the position, title, role etc. associated with the participant making the statement, and semantics pertains to the content and/or meaning of a statement (e.g. summarization of participant's dialogue pertaining to a particular topic, vote, etc.). Statements include inputs to the dialogue such as, but not limited to one or more textual, video, audio, image, or any other applicable type of content configured to be received by conferencing system 140, in which the inputs pertain to questions, reactions, opinions, votes, etc. of participants. Acquiring statement scores assists viewpoint analysis module 160 with the segmenting or grouping participants into groups.

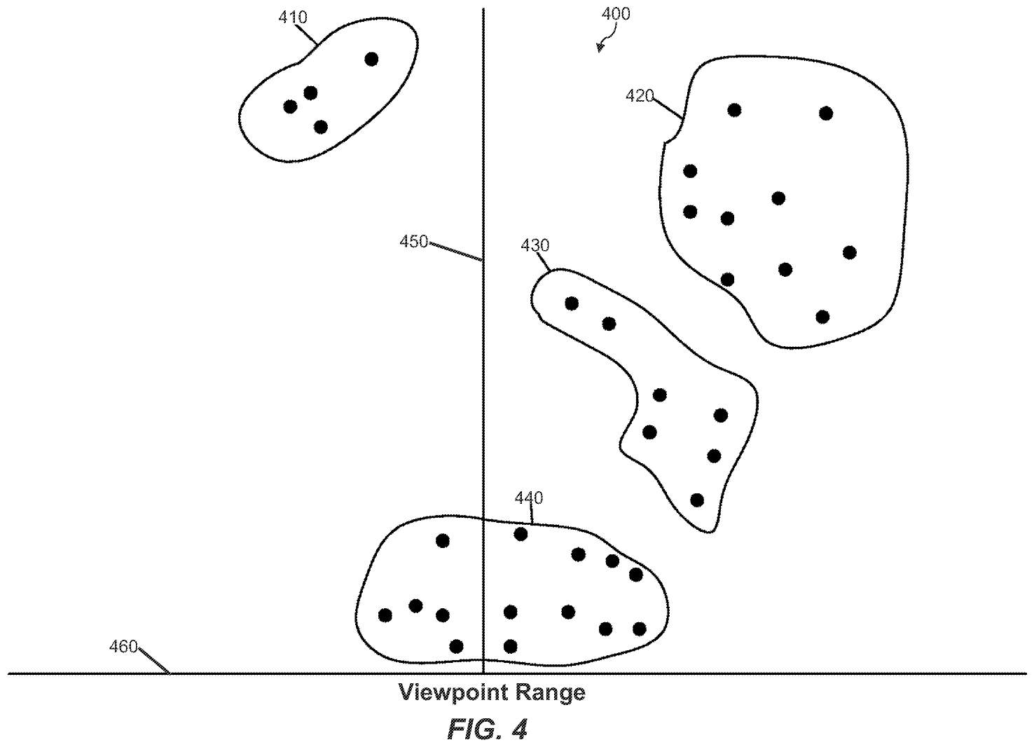

Referring now to FIG. 4, an exemplary user interface 400 of merging of viewpoints based on grouping of participants to ascertain a consensus is depicted, according to an exemplary embodiment. Viewpoint visualization module 180 renders visualizations such as user interface 400 in order to represent the segmenting of participants into groups 410-440 each of which indicate group consensus or disagreement regarding a matter (e.g. a vote relating to an ascertained topic, etc.). In the embodiment shown in FIG. 4, each dot represents viewpoints of respective participants and each of groups 410-440 represent group consensus or disagreement allocated across X-axis 450 representing viewpoint score or statement score if applicable, and Y-axis 460 representing viewpoint range. Viewpoint range may be specific to dialogue topic, voting distribution, time slots, etc. In various embodiments, X-axis 450 and Y-axis 460 may represent viewpoint scores, sentiment scores, statement scores, connection relationship strength scores, etc. FIG. 4 is designed to show merging or synthesizing of viewpoints reflected in groups clustered based on the viewpoint scores. Group consensuses may be ascertained by the degree of consensus in which the degree of consensus may be discovered by viewpoint analysis module 160 determining top-k candidates to a defined threshold, unanimity amongst participants, or any other applicable manner of determining degree of consensus known to those of ordinary skill in the art. In some embodiments, the size of the circling on the visualization (e.g. grouping circle) correlates to the final viewpoint score of the clusters based onΣRsi*REi*Wi. In a working example, each of groups 410-440 may represent a different viewpoint in which group 410 may include negative sentiment, groups 420-430 include positive sentiment, and group 440 includes a neutral sentiment regarding a topic associated with the dialogue of the multi-party discussion dialogue. Due to the synthesizing of viewpoints associated with participants in group 440, near-consensus of viewpoints can be clarified by factoring and weighing of emotions, sentiments, semantics, priority, and ordering (e.g. point in time during the dialogue of the multi-party discussion in which one or more statements of a viewpoint were made), in which near-consensuses may be overcome by threshold determinations. In particular, the synthesizing of viewpoints is useful during the voting process of participants due to the fact that the merging of viewpoints optimizes the clustering performed by viewpoint analysis module 160, which is optimally visualized by viewpoint visualization module 180.

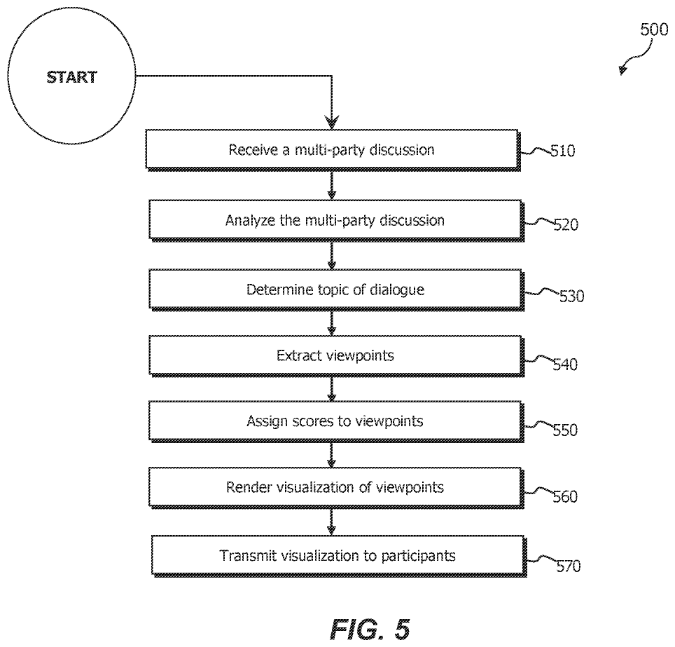

With the foregoing overview of the example architecture, it may be helpful now to consider a high-level discussion of an example process. FIG. 5 depicts a flowchart illustrating a computer-implemented process 500 for visualizing viewpoints, consistent with an illustrative embodiment. Process 500 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 510 of process 500, a multi-party discussion is received by conference media processing module 150. It should be noted that multi-party discussions may be hosted on one more communication channels which may operate on conferencing system 140 or any other applicable telecommunication services providing communication modalities for one or more of text chat, voice chat, videoconferencing, document sharing, screen sharing, etc. Multi-party discussions may include but are not limited to dialogue received by conferencing system 140 in the form of text, audio, multi-media, combinations thereof, or any applicable input configured to be received by multi-party telecommunication channels.

At step 520 of process 500, conference media processing module 150 analyzes the multi-party discussion. As previously mentioned, conference media processing module 150 may utilize machine learning module 170 to perform functions such as natural language processing and audio to text transcribing in order to ascertain a transcript of the multi-party discussion involving the participants. Conference media processing module 150 is configured to process data derived from the channels of communication (e.g. audio data, video data, text data, etc.); and in various embodiments, optical character recognition (“OCR”) techniques may be applied to the transcripts in order to assist with detection of words and/or phrases of importance and relevance within the dialogues of the multi-party discussions that may indicate a viewpoint of a participant being expressed.

At step 530 of process 500, conference media processing module 150 determines one or more topics of the dialogue of the multi-party discussion. One of the purposes of determining topics within the dialogue is to ascertain whether a viewpoint is being expressed by a participant. In some embodiments, viewpoint visualization module 180 is further configured to generate quantifiable visual features designed to indicate emotion based on one or more sentiments expressed by participants during the dialogue. For example during a call to vote occurring among participants within a multi-party discussion, user 130 may vocalize a vehement vote of “no” in which conference media processing module 150 is able to ascertain the negative sentiment resulting in viewpoint visualization module 180 visualizing the negative sentiment in the graph with the ascertained viewpoint via a visual indicator such as but not limited to a “-” sign, a red colored marker, etc. It should be noted that conference media processing module 150 determining the topics of the dialogue results in the viewpoint range being generated which is visualized by viewpoint visualization module 180.

At step 540 of process 500, viewpoint analysis module 160 extracts the plurality of viewpoints from the dialogue of the multi-party discussion. Extraction of the plurality of viewpoints allows viewpoint visualization module 180 to begin rendering visualizations of the viewpoints that not only include statements of the viewpoint if applicable, but also visual indicators associated with attributes of the viewpoints obtained by viewpoint analysis module 160. For example, “+1” indicating positive sentiment and “−1” indicating negative sentiment may be depicted by viewpoint visualization module 180 as overlayed, near, or adjacent to statements of viewpoints or the viewpoints themselves for the purpose of viewing by participants on the centralized platform.

At step 550 of process 500, viewpoint analysis module 160 assigns a viewpoint score to the plurality of viewpoints from the dialogue of the multi-party discussion. The assigning of viewpoint scores to the viewpoints weighs sentiments, semantics, and ordering/prioritization associated with the viewpoints derived from viewpoint analysis module 160 performing one or more analyses on the viewpoints. The equationΣRsi*REi*Wi accounts for the calculation of the score of each viewpoint of each participant of the dialogue of the multi-party discussion.

At step 560 of process 500, viewpoint visualization module 180 generates a visualization of the viewpoints. The visualizations may include visual representations of not only the viewpoints, but also the attributes of viewpoints, the source of the viewpoints (e.g. particular participant expressing the viewpoint, etc.), the time slots associated with the respective viewpoints, and any other ascertainable data associated with the viewpoints configured to be visualized. In some embodiments, the visualizations are designed to be updated in real-time in order to account for merging of viewpoints in addition to additional viewpoints received during the processing of the dialogue.

At step 570 of process 500, viewpoint visualization module 180 transmits the rendered visualizations to participants. In a preferred embodiment, the visualizations include a rendered visualization including synthesized viewpoints based on their respective content being similar. In various embodiments, the visualizations are transmitted to computing device 135 for depiction to user 130 via the centralized platform. In some embodiments, the visualizations are configured to be interactive with user 130 allowing components of the visualizations to be modified via the centralized platform for optimization purposes.

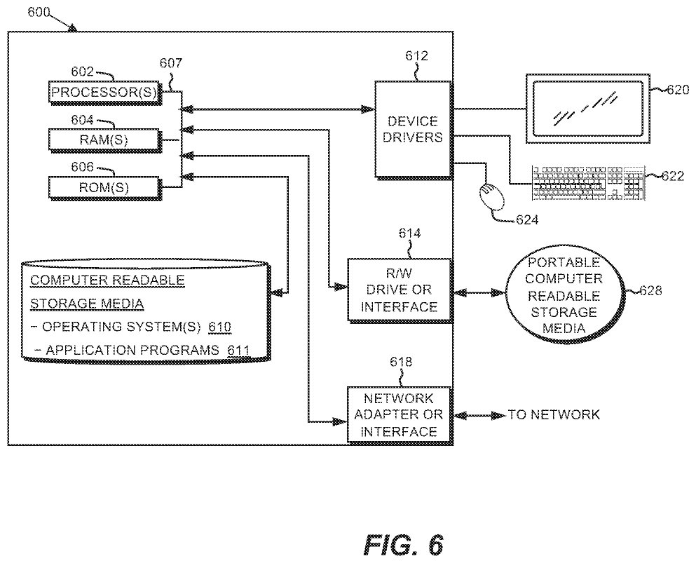

FIG. 6 is a block diagram of components 600 of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 600 is representative of any electronic device capable of executing machine-readable program instructions. Data processing system 600 may be representative of a smart phone, a computer system, PDA, or other electronic devices. Examples of computing systems, environments, and/or configurations that may represented by data processing system 600 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices. The one or more servers may include respective sets of components illustrated in FIG. 6. Each of the sets of components include one or more processors 602, one or more computer-readable RAMs 604 and one or more computer-readable ROMs 606 on one or more buses 607, and one or more operating systems 610 and one or more computer-readable tangible storage devices. The one or more operating systems 610 may be stored on one or more computer-readable tangible storage devices 616 for execution by one or more processors 602 via one or more RAMs 608 (which typically include cache memory). In the embodiment illustrated in FIG. 6, each of the computer-readable tangible storage devices 616 is a magnetic disk storage device of an internal hard drive. Alternatively, each of the computer-readable tangible storage devices is a semiconductor storage device such as ROM 606, EPROM, flash memory or any other computer-readable tangible storage device that can store a computer program and digital information.

Each set of components 600 also includes a R/W drive or interface 614 to read from and write to one or more portable computer-readable tangible storage devices 628 such as a CD-ROM, DVD, memory stick, magnetic tape, magnetic disk, optical disk or semiconductor storage device. A software program can be stored on one or more of the respective portable computer-readable tangible storage devices 628, read via the respective RAY drive or interface 614 and loaded into the respective hard drive.

Each set of components 600 may also include network adapters (or switch port cards) or interfaces 618 such as a TCP/IP adapter cards, wireless wi-fi interface cards, or 3G or 4G wireless interface cards or other wired or wireless communication links. Applicable software can be downloaded from an external computer (e.g. server) via a network (for example, the Internet, a local area network or other, wide area network) and respective network adapters or interfaces 618. From the network adapters (or switch port adaptors) or interfaces 618, the centralized platform is loaded into the respective hard drive. The network may comprise copper wires, optical fibers, wireless transmission, routers, firewalls, switches, gateway computers and/or edge servers.

Each of components 600 can include a computer display monitor 620, a keyboard 622, and a computer mouse 624. Components 600 can also include touch screens, virtual keyboards, touch pads, pointing devices, and other human interface devices. Each of the sets of components 600 also includes device drivers 612 to interface to computer display monitor 620, keyboard 622 and computer mouse 624. The device drivers 612, R/W drive or interface 614 and network adapter or interface 618 comprise hardware and software (stored in RAM 604 and/or ROM 606).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g. mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g. country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g. storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g. web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g. host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g. mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g. cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

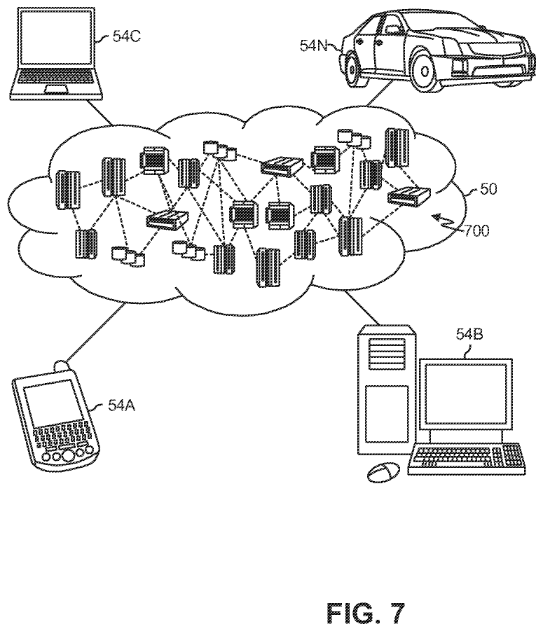

Referring now to FIG. 7, illustrative cloud computing environment 700 is depicted. As shown, cloud computing environment 700 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 54A-N shown in FIG. 6 are intended to be illustrative only and that computing nodes 50 and cloud computing environment 700 can communicate with any type of computerized device over any type of network and/or network addressable connection (e.g. using a web browser).

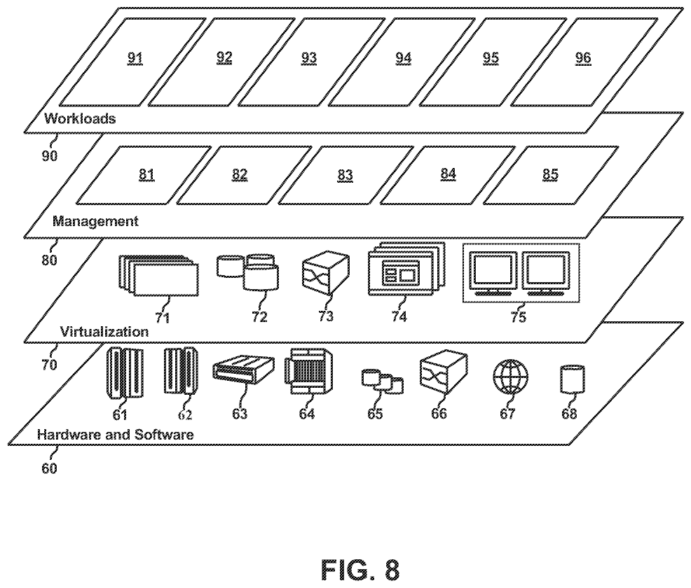

Referring now to FIG. 8 a set of functional abstraction layers provided by cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and viewpoint visualization generation 96. Viewpoint visualization generation 96 relates to generating visualizations of viewpoints of participants in multi-party discussions and derivatives thereof.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for visualizing viewpoints comprising:
receiving, by a computing device, access to a multi-party discussion occurring via a telecommunication system;
analyzing, by the computing device, the multi-party discussion using natural language processing;
extracting, by the computing device, a plurality of viewpoints of the multi-party discussion based on the analysis;
synthesizing, by the computing device, a subset of the plurality of viewpoints based on the content of each viewpoint of the plurality of viewpoints; and
transmitting, by the computing device, a rendered synthesized visualization of the subset.

2. The computer-implemented method of claim 1, further comprising:
generating, by the computing device, a consensus relating to a vote of participants of the multi-party discussion associated with the subset of the plurality of viewpoints; and
rendering, by the computing device, a viewpoint visualization of the plurality of viewpoints including the consensus for viewing by the participants.

3. The computer-implemented method of claim 1, wherein extracting the plurality of viewpoints comprises:
identifying, by the computing device, a topic of dialogue associated with the plurality of viewpoints;
identifying, by the computing device, at least one viewpoint factor of each viewpoint relating to the topic; and
assigning, by the computing device, a score to each viewpoint of the plurality of viewpoints based on the at least one viewpoint factor.

4. The computer-implemented method of claim 3, wherein the viewpoint factor is one or more of a sentiment of the viewpoint, a statement order of the viewpoint, or a semantic of the viewpoint.

5. The computer-implemented method of claim 2, wherein the viewpoint visualization of the consensus comprises:
a graph comprising a plurality of shapes each shape representing a viewpoint of the plurality of viewpoints;
wherein a merging of at least two shapes of the plurality of shapes in the graph represents the synthesizing of the subset indicating similarity of the content of the viewpoints within the subset.

6. The computer-implemented method of claim 3, wherein the rendered synthesized visualization comprises a clustering of the plurality of viewpoints based on the score.

7. The computer-implemented method of claim 2, wherein assigning the score to each viewpoint comprises:
computing, by the computing device, the equation: ΣRSi*REi*Wi, wherein RSi is a similarity of a viewpoint, REi is a sentiment of a viewpoint, and Wi is a weight of a viewpoint.

8. The computer-implemented method of claim 1, wherein analyzing the multi-party discussion further comprises:
generating, by the computing device, a transcript of the dialogue of the multi-party discussion;
training, by the computing device, a machine learning based conversational agent by marking speech patterns of a plurality of statements of the dialogue;
wherein the markings collectively represent a viewpoint of a participant in the multi-party discussion.

9. A computer system for visualizing viewpoints, the computer system comprising:
one or more processors,
one or more computer-readable memories;
program instructions stored on at least one of the one or more computer-readable memories for execution by at least one of the one or more processors, the program instructions comprising:
program instructions to receive access to a multi-party discussion occurring via a telecommunication system;
program instructions to analyze the multi-party discussion using natural language processing;
program instructions to extract a plurality of viewpoints of the multi-party discussion based on the analysis;
program instructions to synthesize a subset of the plurality of viewpoints based on the content of each viewpoint of the plurality of viewpoints; and
program instructions to transmit a rendered synthesized visualization of the subset.

10. The computer system of claim 9, further comprising:
program instructions to generate a consensus relating to a vote of participants of the multi-party discussion associated with the subset of the plurality of viewpoints; and
program instructions to render a viewpoint visualization of the plurality of viewpoints including the consensus for viewing by the participants.

11. The computer system of claim 9, wherein the program instructions to extract the plurality of viewpoints further comprise:
program instructions to identify a topic of dialogue associated with the plurality of viewpoints;
program instructions to identify at least one viewpoint factor of each viewpoint relating to the topic; and
program instructions to assign a score to each viewpoint of the plurality of viewpoints based on the at least one viewpoint factor.

12. The computer system of claim 9, wherein the viewpoint factor is one or more of a sentiment of the viewpoint, a statement order of the viewpoint, or a semantic of the viewpoint.

13. The computer system of claim 9, wherein the viewpoint visualization of the consensus comprises:
a graph comprising a plurality of shapes each shape representing a viewpoint of the plurality of viewpoints;
wherein a merging of at least two shapes of the plurality of shapes in the graph represents the synthesizing of the subset indicating similarity of the content of the viewpoints within the subset.

14. The computer system of claim 9, wherein program instructions to assign the score to each viewpoint comprises:
program instructions to compute the equation: ΣRSi*REi*Wi, wherein RSi is a similarity of a viewpoint, REi is a sentiment of a viewpoint, and Wi is a weight of a viewpoint.

15. The computer system of claim 9, wherein program instructions to analyze the multi-party discussion further comprises:
program instructions to generate a transcript of the dialogue of the multi-party discussion; and
program instructions to train a machine learning based conversational agent by marking speech patterns of a plurality of statements in the transcript;
wherein the markings collectively represent a viewpoint of a participant in the multi-party discussion.

16. A computer program product for visualizing viewpoints, the computer program product comprising a computer readable storage medium having program instructions embodied therewith, wherein the computer readable storage medium is not a transitory signal per se, the program instructions being executable by a processor to cause the processor to perform a method comprising:
receiving access to a multi-party discussion occurring via a telecommunication system;
analyzing the multi-party discussion using natural language processing;
extracting a plurality of viewpoints of the multi-party discussion based on the analysis;
synthesizing a subset of the plurality of viewpoints based on the content of each viewpoint of the plurality of viewpoints; and
transmitting a rendered synthesized visualization of the subset.

17. The computer program product of claim 16, further comprising:
generating a consensus relating to a vote of participants of the multi-party discussion associated with the subset of the plurality of viewpoints; and
rendering a viewpoint visualization of the plurality of viewpoints including the consensus for viewing by the participants.

18. The computer program product of claim 16, wherein extracting the plurality of viewpoints comprises:
identifying a topic of dialogue associated with the plurality of viewpoints;
identifying at least one viewpoint factor of each viewpoint relating to the topic; and
assigning a score to each viewpoint of the plurality of viewpoints based on the at least one viewpoint factor.

19. The computer program product of claim 16, wherein the viewpoint visualization of the consensus comprises:
a graph comprising a plurality of shapes each shape representing a viewpoint of the plurality of viewpoints;
wherein a merging of at least two shapes of the plurality of shapes in the graph represents the synthesizing of the subset indicating similarity of the content of the viewpoints within the subset.

20. The computer program product of claim 16, wherein assigning the score to each viewpoint comprises:
computing the equation: ΣRSi*REi*Wi, wherein RSi is a similarity of a viewpoint, REi is a sentiment of a viewpoint, and Wi is a weight of a viewpoint.
